(19) United States
(12) Patent Application Publication
(10) Pub. No.: US 2009/0298585 A1
(43) Pub. Date: Dec. 3, 2009

(54) ENHANCEMENT FOR A VIDEO GAME CONTROLLER TO ALLOW PRIVATE INTERACTION WITH THE USER

(75) Inventors: ULYSSES LAMONT CANNON, DURHAM, NC (US); ANGELA RICHARDS JONES, DURHAM, NC (US); RUTHIE D. LYLE, DURHAM, NC (US); SUSAN S. MCVEY, SAN JOSE, CA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/131,693

(22) Filed: Jun. 2, 2008

(51) Int. Cl. A63F 13/00; A63F 9/24

(52) U.S. Cl. 463/31; 463/36

(57) ABSTRACT

The present invention can allow for private interactions with game players on a single game console. The present invention can include a game controller enhancement to include a private screen, which can display information to each player that should be private. The game controller enhancement can also include private audio support, which can allow the player to hookup an audio device, such as a headset, to receive audio only intended for the user. These enhanced game controllers can be used with supported game software. In some embodiments, the game controllers can have multiple modes of input. The game controller can include a toggle mechanism to switch between modes. One mode can allow the game controller controls to be sent to the game console. Another mode can allow the game controller control over (I/O control) to what is being privately shown to the user. In some embodiments, a toggle mechanism can be omitted and game software can switch the input modes appropriately.

### BACKGROUND OF THE INVENTION

The present invention relates to the field of electronic entertainment, more particularly, to an enhancement for a video game controller to allow private interaction with the user.

In the history of multiplayer video gaming, it has been a common problem adapting some games to be multiplayer on a single gaming machine. One major reason for this is the need for privacy at certain times while playing a game. For example, players could be playing a multiplayer sports game. Using a single gaming machine to display all contents of the game forces a player to choose strategic plays in full view of their opponent. In another example, players can be playing a real-time strategy game (i.e. a war strategy game). In this game, players can be responsible for placing units on a battlefield and using those units to combat with the other players. If the game was played multiplayer on a single console, the placement of a player's units would be revealed and the game would be unplayable.

Requiring additional gaming machines for each player can be extremely expensive. Because of the costs associated with buying a game console for each player, the number of players capable of playing such games are few in number. An intuitive solution is needed to allow private interaction with players on a single gaming machine for multiplayer play.

### BRIEF DESCRIPTION OF THE SEVERAL VIEWS OF THE DRAWINGS

FIG. 1 is a schematic diagram of a system for an enhancement for a video game controller to allow private interaction with the user in accordance with an embodiment of the inventive arrangements disclosed herein.

FIG. 2 is a schematic diagram of a system for an enhancement for a video game controller to allow private interaction with the user in accordance with an embodiment of the inventive arrangements disclosed herein.

FIG. 3 illustrates a possible embodiment for an enhancement for a video game controller to allow private interaction with the user in accordance with an embodiment of the inventive arrangements disclosed herein.

FIG. 4 is a flow chart of a method for using an enhancement for a video game controller to allow private interaction with the user in accordance with an embodiment of the inventive arrangements disclosed herein.

### DETAILED DESCRIPTION OF THE INVENTION

The present invention can allow for private interactions with game players on a single game console. The present invention can include a game controller enhancement to include a private screen, which can display information that should be private to the respective player. The game controller enhancement can also include private audio support, which can allow the player to hookup an audio device, such as a headset, to receive audio only intended for the user. These enhanced game controllers can be used with supported game software. In some embodiments, the game controllers can have multiple modes of input. The game controller can include a toggle mechanism to switch between modes. One mode can allow the game controller controls to be sent to the game console. Another mode can allow the game controller control over (I/O control) what is being privately shown to the user. In some embodiments, a toggle mechanism can be omitted and game software can switch the input modes appropriately.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

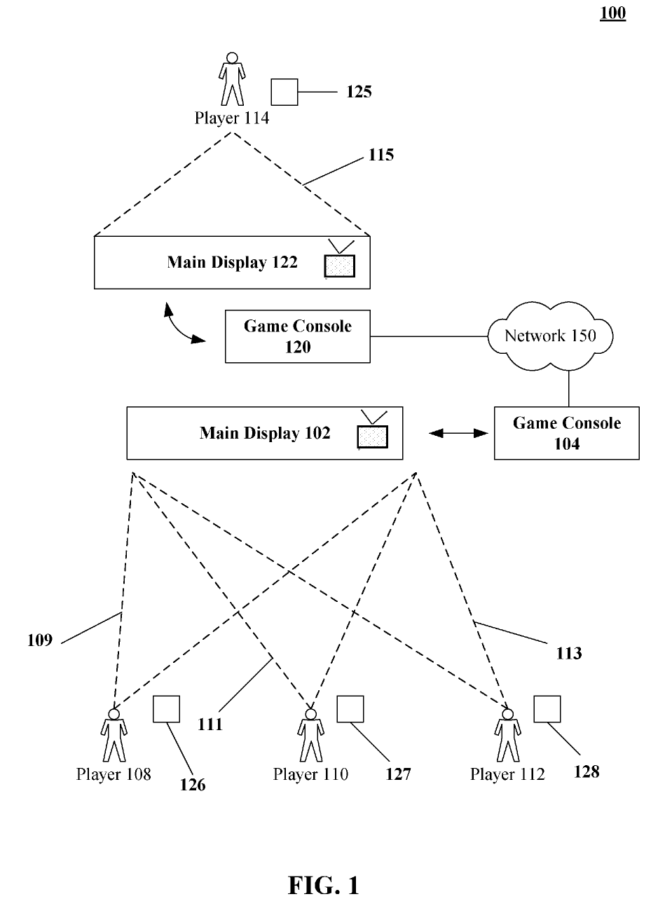

FIG. 1 is a schematic diagram of a system 100 for an enhancement for a video game controller to allow private interaction with the user in accordance with an embodiment of the inventive arrangements disclosed herein. System 100 can include players 108, 110, 112, and 114. These players can be involved in the same gaming session. Players 108, 110, 112, and 114 can be interacting with the game using main displays 102 and 122 and game consoles 104 and 120. Game consoles 120 and 104 can be connected via network 150. Player 114 can be using controller 125 to interact with game console 120. Player 108 can be using controller 126, player 110 can be using controller 127, and player 112 can be using controller 128 to interact with game console 104. Each controller 125-128 can include private displays to convey private data to players 108, 110, 112, and 114. Because player 114 has an entire main display 122 to himself, private data for player 114 can be displayed in main display 122.

Main displays 122 and 102 can be the main display used to display the game software being played. Main display 122 can allow player 114 to interact with the game software in full screen. In some embodiments, depending on the game software, main display 102 can be split into independent display areas for each player 108, 110, and 112. Even though these independent display areas can be provided, it can still be inappropriate for displaying private information for each player. Main displays 122 and 102 can be any display device including, but not limited to, a television, computer monitor, handheld display, or the like.

Game consoles 120 and 104 can be any computing devices capable of running game software and interacting with game controllers 125-128. Game consoles 120 and 104 can run game software and respond to user-driven events. Game consoles 120 and 104 can output video and audio to main displays 122 and 102. If the private displays are activated on game controllers 125-128, game consoles 120 and 104 can also convey audio and video to the game controllers in which the private displays are activated. Game consoles 120 and 104 can be any gaming machine, including, a computer, SONY PLAYSTATION, NINTENDO WII, MICROSOFT XBOX, and the like.

Players 108, 110, 112, and 114 can be users involved in a gaming session provided by game consoles 120 and 104 via network 150. Player 114 can be associated with viewing angle 115. Viewing angle 115 can illustrate player 114's view of main display 122. Player 108 can be associated with viewing angle 109, player 110 can be associated with viewing angle 111, and player 112 can be associated with viewing angle 113. Viewing angles 109, 111, and 113 can illustrate views of main display 102. Viewing angle 115 illustrates that player 114 has a view that does not cross with any other player's and therefore a private display on controller 125 is not needed. Player 108, 110, and 112's viewing angles interfere with each other and therefore require a private display for private information.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

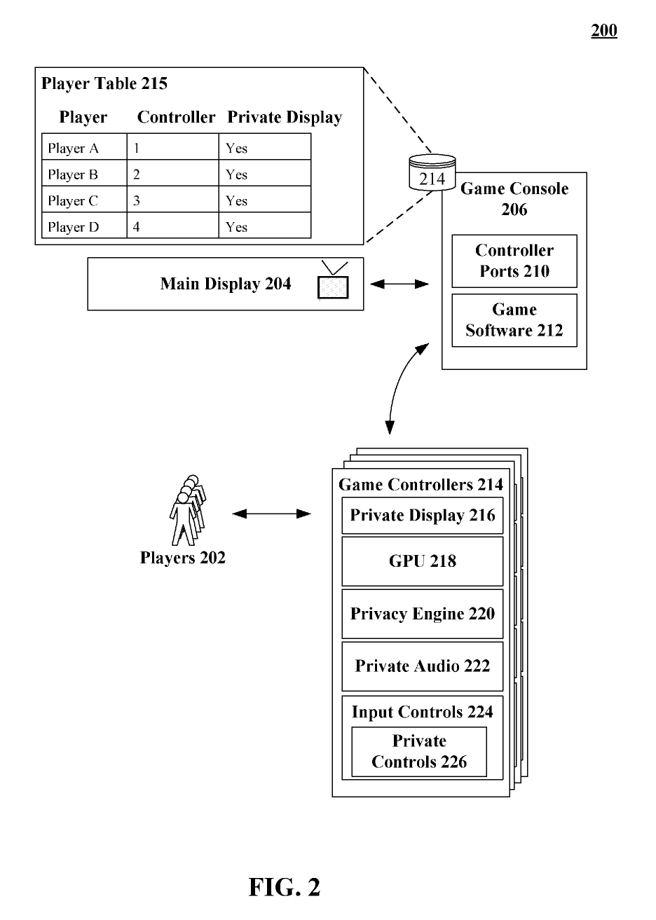

FIG. 2 is a schematic diagram of a system 200 for an enhancement for a video game controller to allow private interaction with the user in accordance with an embodiment of the inventive arrangements disclosed herein. System 200 can include main display 204, game console 206, game controllers 214, and players 202. Players 202 can interact with game controllers 214 to interact with game console 206. Game console 206 can be in context of game consoles 120 and 104 of system 100. Game controllers 214 can be in context of game controllers 125-128 of system 100. Players 202 can view the output of game console 206 on main display 204 and the embedded private display 216 of game controllers 214. Main display 204 can be in context of main displays 122 and 102 of system 100. When moments of the game are encountered where private interaction with a player 202 is required, game software 212 can enable a private display 216 of the controller associated with the player. In some embodiments, game software 212 can switch the currently used input mode. For example, when the private display 216 of the game controller 214 is enabled, input controls 224 can be ignored and private controls 226 can be used. In other embodiments, game controllers 214 can include a toggle mechanism (not shown) to allow the manual switching between input modes. Game controller 214 can also include privacy engine 220, GPU 218, and private audio 222. Privacy engine 220 can receive data from game software 212 to provide to GPU 218 to display on private display 216. Privacy engine 220 can also convey private input to game software 212. Such private input can be response to information on private display 216 or can be data provided through private audio 222. Player table 215 can illustrate a table describing the players in the gaming session, their associated controller, and whether or not a private display is available. Player table 215 can be stored on data store 214 of game console 206.

Controller ports 210 can provide all communication functionality between game console 206 and game controllers 214. Controller ports 210 can support a wired or wireless connection and can allow the conveyance of input between controllers 214 and console 206. Controller ports 210 can be USB, BLUETOOTH, WIFI, serial, or the like.

Game software 212 can be machine-readable instruction code executable by game console 206. Game software 212 can include the content and code necessary to provide a video game session for players 202. Game software 212 can include support for privacy engine 220. Game software 212 can send and receive data to and from privacy engine 220 through controller ports 210. Game software 212 can allow the sending and receiving of audio to and from game controllers 214. Game software 212 can also provide the content to display on private display 216 to privacy engine 220. Privacy engine 220 can convey input provided by private controls 226 to game software 212.

Private display 216 can be a display screen embedded into game controllers 214. Private display 216 can display private information to each player 202. Private display 216 can be controlled by GPU 218. In some embodiments, private display 216 can be touch sensitive. In these embodiments, private display 216 can input private controls 226. Private display 216 can be any display screen, including, but not limited to, an LCD screen, plasma screen, and the like.

Privacy engine 220 can provide the functionality of controlling the private data associated with game controllers 214. Privacy engine 220 can receive data to be displayed on private display 216 and provide it to GPU 218 for processing and displaying on private display 216. Privacy engine 220 can receive audio data from game software 212 and convey it to private audio 222. Private audio 222 can also provide audio data to privacy engine 220 for conveyance to game software 212.

GPU 218 can be a graphics processor for private display 216. GPU 218 can receive raw graphics data from privacy engine 220 and then render them for display on private display 216. In some embodiments, GPU 218 can include 3d acceleration functionality.

Private audio 222 can provide audio input and output for game controllers 214. For example, private audio 222 can include an audio headphone jack. This can allow a player 202 to connect a headset with a microphone. In this situation, private audio 222 can collect audio data through the headset's microphone and convey it to privacy engine 220. Private audio 222 can also play received audio data through the headset for the player.

Input controls 224 can include all of the input mechanisms on the game controller intended for interaction with the game software. Depending on the implementation, the game controller's layout and number of buttons can vary greatly. Input controls 224 can include the game controller's face buttons, shoulder buttons, analog sticks, digital pads, and the like.

Private controls 226 can include the controls for private interaction with game software 212. Private controls 226 can implement the same controls included in input controls 224, but can require the switching of an input mode. This mode can switch automatically or manually. In some embodiments, private controls 226 can include additional controls meant only for private interaction. For example, private display 216 can implement private controls 226 in the form of a touch sensitive display. In another example, buttons can be associated with the private display to only be used for private interaction.

Player table 215 can illustrate a table for managing the players in the game session on game console 206. Player table 215 can include the fields player, controller, and private display. The player field can include the player's unique ID. In some embodiments, this can be the player's online user ID, a temporary nickname, or the like. The controller field can be used to store the controller ID associated with the player. The private display field can be used to store whether or not the player's controller has private display support.

Data store 214 can be physically implemented within any type of hardware including, but not limited to, a magnetic disk, an optical disk, a semiconductor memory, a digitally encoded plastic memory, a holographic memory, or any other recording medium. The data store 214 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

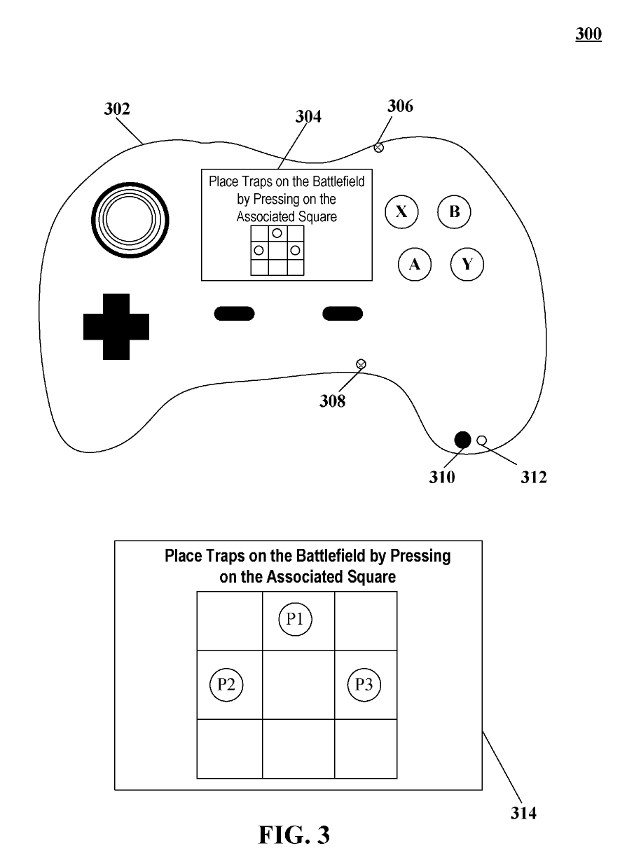

FIG. 3 illustrates a possible embodiment for an enhancement for a video game controller to allow private interaction with the user in accordance with an embodiment of the inventive arrangements disclosed herein. In FIG. 3, game controller 302 can be in the context of game controllers 214 of system 200. Game controller 302 can include private display 304. Display 314 can be an expanded view of display 304. Input toggle buttons 306 and 308 illustrate locations for button placement to allow the switching between input modes. Game controller 302 can have separate input modes for when the included buttons should control the private display 304 or when the included buttons should control the game software. When an input toggle button 306 or 308 is toggled, the input mode can switch for game controller 302. Buttons 306 and 308 are just two contemplated positions for the functionality. It is contemplated that in some embodiments, buttons 306 and 308 can be entirely omitted and the game software can automatically detect when input modes should be switched. Game controller 302 can include an embedded pointing device 310. When button 312 is pressed, it can allow the release of pointing device 3 10. A pointing device 310 is not needed in embodiments where private display 304 is not touch sensitive.

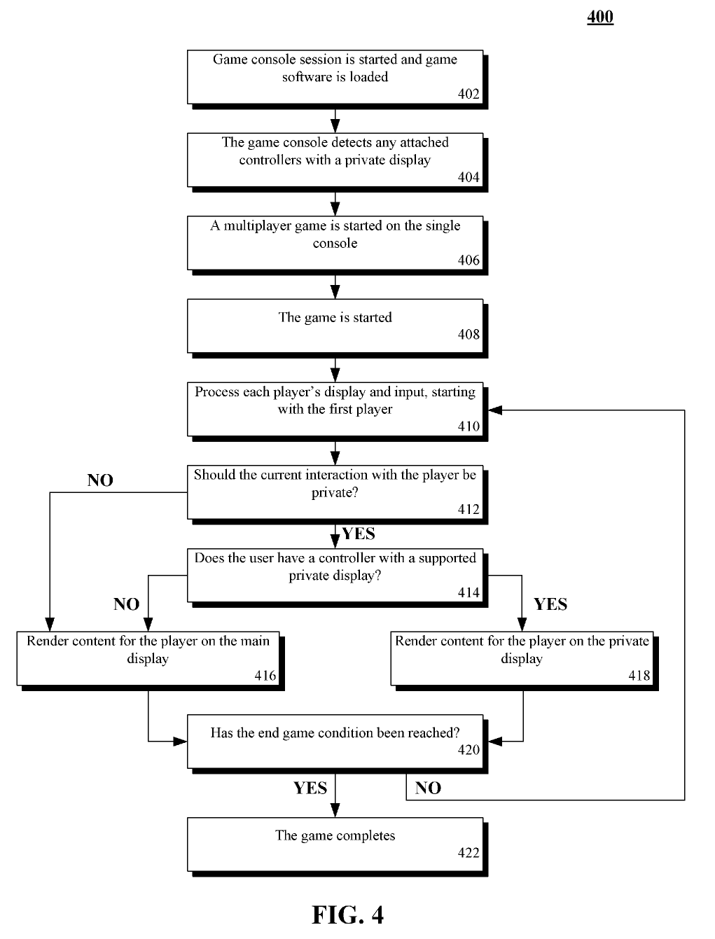

FIG. 4 is a flow chart of a method 400 for using an enhancement for a video game controller to allow private interaction with the user in accordance with an embodiment of the inventive arrangements disclosed herein. Method 400 can begin in step 402, where a game console session can be started and game software can be loaded. In step 404, the game console can detect any attached controllers with a supported private display. In step 406, a multiplayer game can be started on the single game console. In step 408, the game can begin. In step 410, the game software can process each player's display and input, starting with the first player. In step 412, the game software can determine if the current interaction with the player should be private. If the interaction with the player should be private, method 400 can continue to step 414, where the game software can determine if the player is using a controller with a supported private display. If in step 412, the interaction should not be private, method 400 can continue to step 316, where the player's content can be rendered on the main display.

If in step 414, the user has a controller with a supported private display, method 400 can continue to step 418, where the player's content can be rendered on the supported private display. If in step 414, the user does not have a controller with a supported private display, method 400 can continue to step 316, where the player's content can be rendered on the main display. After steps 316 or 318 are completed, method 400 can continue to step 420, where the game software can determine if an end game condition has been reached (i.e. the player has won or lost the game). If the end game condition has not been reached, method 400 can loop back to step 410, where the game software can continue to process each player's display and input. If in step 420, an end game condition has been reached, method 400 can continue to and complete in step 422, where the game session can complete.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A video game system comprising:
a game console that is a computing device configured to execute game software, which permits user interactions with the game with at least one game controller communicatively coupled to the game console;
a main display communicatively linked to the game console, wherein the main display is configured to present visual output for game software executing upon the game console; and
at least one private display communicatively linked to the game console, wherein the private display is configured to present visual output for game software executing upon the game console; and
a privacy engine configured to detect private interactions in context of game software executing upon the game console and to direct output for private interactions to the private display, wherein default output for non-private interactions is directed to the main display, wherein the private display is a display embedded in the game controller.

2. The system of claim 1, wherein the at least one game controller comprises a plurality of game controllers, each having an embedded private display, wherein the game console is configured to associate each of the plurality of game controllers with a user participating in an interactive game executing upon the game console, wherein the game control is configured to direct user-specific interactions that are private interactions to private display of a game controller associated with the user to whom the user-specific interactions are directed.

3. The system of claim 1, further comprising:
a main audio component communicatively linked to the game console configured to present audio output for game software executing upon the game console; and
a private audio component embedded in the game controller, wherein the privacy engine is configured to direct audio output for private interactions to the private audio component and is configured to direct video output for private interactions to the private display.

4. The system of claim 1, wherein the game console is an interactive entertainment device that utilizes proprietary operating system and proprietary game controllers designed specially for a proprietary gaming platform.

5. The system of claim 1, wherein the game console is a personal computer and wherein each of the game controllers are peripherals of the personal computer.

6. A video game controller comprising:
a plurality of input controls, each comprising a user selectable input component through which a user can interact with game software executing upon a game console;
a private display configured to present visual output for game software executing upon the game console, wherein said video game controller is configured to be communicatively linked to the game console, wherein the game console is configured to direct interactions labeled as private interactions to the private display and is configured to direct default interactions to a main display different from the private display.

7. The video game controller of claim 6, wherein the private display comprises at least one of a Liquid Crystal Display (LCD) display, an organic electroluminescent material (OEL) display, a vacuum fluorescent display (VFD), a Field emission display (FED), an organic light-emitting diode (OLED) display, a liquid crystal on silicon (LCOS), a field emission display (FED), a plasma display, a surface-conduction electron-emitter display (SED), and an electrophoretic display.

8. The video game controller of claim 6, further comprising:
a private audio component configured to present audio output for game software executing upon the game console, wherein the game console is configured to audio portions of direct interactions labeled as private interactions to the private audio component.

9. The video game controller of claim 6, further comprising:
a graphic processor unit configured to process input from the game controller and to visually render the input upon the private display.

10. A method of interacting with electronic games comprising:
providing a plurality of game controllers for a game console configured to execute electronic games, wherein each of the plurality of game controllers comprises a private display;
detecting private output directed towards a player of an interactive game executing upon the game console;
determining which of the game controllers is associated with the detected private output;
conveying the private output to the determined game controller; and
visually presenting the private output upon the private display of the determined game controller.

11. The method of claim 10, further comprising:
detecting default output not considered private that is part of the interactive game;
conveying the default output to a main display; and
visually presenting the default output upon the main display, wherein the private output presented upon the private display is not presented upon the main display.

12. The method of claim 10, further comprising:
detecting input to the determined game controller;
determining that the input is associated with the private output; and
programmatically interpreting the determined input differently from input entered via the determined game controller that is associated with output presented upon a main display.
